(19) United States
(12) Patent Application Publication
(10) Pub. No.: US 2012/0033294 A1
(43) Pub. Date: Feb. 9, 2012

(54) OPTICAL APPARATUS, SYSTEM AND METHOD EMPLOYING AN ENDOHEDRAL METALLOFULLERENE

(76) Inventors: Raymond G. Beausoleil, Redmond, WA (US); Qianfan Xu, Houston, TX (US); Charles M. Santori, Sunnyvale, CA (US); David A. Fattal, Mountain View, CA (US); Marco Fiorentino, Mountain View, CA (US)

(21) Appl. No.: 13/258,397

(22) PCT Filed: Apr. 30, 2009
(86) PCT No.: PCT/US09/42437

§ 371 Date: Sep. 21, 2011

(51) Int. Cl. H01S 3/067; G02B 6/26

(52) U.S. Cl. 359/341.3; 385/32

(57) ABSTRACT

An optical apparatus (100), an optical system (200) and a method (300) of light amplification by stimulated emission employ an endohedral metallofullerene (120, 220) as an active material coupled to an optical waveguide (110, 210). The endohedral metallofullerene (120, 220) is optically coupled to an optical field of the optical waveguide (110, 210). The coupled optical field produces a stimulated emission in the endohedral metallofullerene (120, 220). The optical system (200) further includes an optical source (230) that generates optical power (232) to pump a stimulated emission. The method (300) further includes optically pumping (330) the coupled endohedral metallofullerene by introducing an optical pump into the optical waveguide.

### CROSS-REFERENCE TO RELATED APPLICATIONS

N/A

### STATEMENT REGARDING FEDERALLY SPONSORED RESEARCH OR DEVELOPMENT

N/A

### BACKGROUND

1. Technical Field

The invention relates to photonic devices. In particular, the invention relates to lasers and optical amplifiers.

2. Description of Related Art

Photonic devices and systems that employ photonic devices are increasing in both deployed quantity and functional complexity. Concomitant with increasing functional complexity is a need to realize functional blocks and elements within photonic devices and systems in a cost effective manner. For example, there is considerable interest in developing active devices such as lasers and laser-based optical amplifiers that exhibit commercially attractive operational capabilities that are also compatible with and readily fabricated as integrated circuits. Often the twin constraints imposed by commercially attractive operational capabilities and integrated circuit fabrication compatibility has resulted in photonic devices and systems based solely on III-V semiconductor junction devices. Relatively recently interest has turned to identifying and developing alternative materials for use as the active material or gain medium for use in lasers and laser amplifiers. For example, active materials that incorporate various rare earth elements have generated a great deal of interest. Chief among the current and future challenges to producing photonic devices and photonic systems using such newly developed active materials is developing a means for integrating these materials with other photonic elements.

### BRIEF DESCRIPTION OF THE DRAWINGS

The various features of embodiments of the present invention may be more readily understood with reference to the following detailed description taken in conjunction with the accompanying drawings, where like reference numerals designate like structural elements, and in which:

FIG. 1A illustrates a perspective view of an optical apparatus, according to an embodiment of the present invention.

FIG. 1B illustrates a cross sectional view of the optical apparatus, illustrated in FIG. 1A, according to an embodiment of the present invention.

FIG. 2A illustrates a perspective view of an optical apparatus, according to another embodiment of the present invention.

FIG. 2B illustrates a cross sectional view of the optical apparatus, illustrated in FIG. 2A, according to another embodiment of the present invention.

FIG. 3 illustrates a block diagram of an optical system, according to an embodiment of the present invention.

FIG. 4 illustrates a perspective view of an optical system that comprises a resonator, according to an embodiment of the present invention.

FIG. 5 illustrates a top view of an optical system that comprises a resonator, according to another embodiment of the present invention.

FIG. 6 illustrates a flow chart of a method of light amplification by stimulated emission, according to an embodiment of the present invention.

Certain embodiments of the present invention have other features that are one of in addition to and in lieu of the features illustrated in the above-referenced figures. These and other features of the invention are detailed below with reference to the preceding drawings.

### DETAILED DESCRIPTION

Embodiments of the present invention provide light amplification by stimulated emission at optical wavelengths using a fullerene-based active material. In particular, according to various embodiments, the fullerene-based active material comprises an endohedral metallofullerene. Exposing the endohedral metallofullerene of the fullerene-based active material to an optical pump (i.e., by optical pumping) facilitates the stimulated emission. The stimulated emission produced by the optically pumped endohedral metallofullerene may be employed to achieve optical (i.e., laser) amplification, for example. The optical amplification provided by embodiments of the present invention may be useful in a variety of applications including, but not limited to, lasers for generating light as well as optical amplifiers that increase an intensity or optical power of an optical signal. Furthermore, an optical apparatus constructed according to embodiments of the present invention, which comprises the endohedral metallofullerene coupled to an optical waveguide, may be realized as a relatively small and compact structure on a substrate. Such an optical apparatus that comprises the optical waveguide and the coupled endohedral metallofullerene serving as the active material may facilitate integration of the optical apparatus of the present invention with other optical components in a photonic system, for example.

According to various embodiments of the present invention, the endohedral metallofullerene is defined as a fullerene that encloses or contains in a fullerene cage one or more atoms or ions of a metal. In particular, the endohedral metallofullerene may be described by a general chemical formula (1):

MₘSₛ@Cₙ (1)

where ‘C’ represents carbon arranged as an effectively closed fullerene cage (e.g., a ‘buckyball’), M represents a metal ion trapped inside the fullerene cage, m is an integer (e.g., m=1, 2, 3, . . . ), S is another species within the fullerene cage, s is an integer (e.g., s=0, 1, 2, 3, . . . ), and n is an integer that is generally greater than 20. For example, n may be selected from 20, 28, 60, 80, and 82. The ‘@’ symbol denotes that the metal ions Mₘ and other species Sₛ are generally contained by but not necessarily chemically bonded to the fullerene cage. In other words, the fullerene is effectively ‘doped’ by the metal atom(s). For example, an endohedral metallofullerene containing one or more erbium (Er) ions (e.g., Mₘ=Er₂) may be referred to as an ‘erbium-doped’ endohedral metallofullerene. An endohedral metallofullerene containing one or more praseodymium (Pr) ions (e.g., Mₘ=Pr₃) may be referred to as a ‘praseodymium-doped’ endohedral metallofullerene, for example. The other species Sₛ include, but are not limited to, nitrogen (N) and carbon (C).

In some embodiments, the metal ion Mₘ contained by the fullerene cage of the endohedral metallofullerene comprises one or more of the so-called ‘rare earths’. The rare earths include, but are not limited to, scandium (Sc), yttrium (Y), and the lanthanoids (i.e., the fifteen elements having atomic weights between 57 and 71) which include, but are not limited to, lanthanum (La), neodymium (Nd), erbium (Er), and ytterbium (Yb). For example, the endohedral metallofullerene may be described as Er₂@C₈₂ which is a fullerene cage having 82 carbon atoms that contains or is doped with 2 erbium (Er) ions. Similarly, Yb₂Nd@C₈₀ is a fullerene cage having 80 carbon atoms that contains 2 ytterbium (Yr) ions along with one neodymium (Nd) ion. In yet another example, Pr@C₈₂ represents an endohedral metallofullerene comprising praseodymium (Pr).

In some embodiments, the fullerene cage may be a modified fullerene. That is, the fullerene cage may not be a pure fullerene. In some of these embodiments, the modified endohedral metallofullerene may be modified by the addition of atoms, molecules, or other groups to the fullerene cage while still preserving the basic fullerene cage structure. For example, the modified endohedral metallofullerene may be formed by adding one or more hydrogen (H) atoms (e.g., by hydrogenation) to the fullerene cage.

The modified endohedral metallofullerene may be described by a chemical formula (2):

MₘSₛ@CₙRₖ (2)

where ‘R’ represents a group or groups added to the fullerene cage and k is an integer. In some embodiments, the group R is hydrogen (R=H) that is added by hydrogenation of the fullerene cage. Modification, in general, and hydrogenation, in particular, may increase an intensity of a fluorescence response (e.g., a stimulated emission) of the endohedral metallofullerene, according to some embodiments. When considering hydrogenation, the hydrogenation may be partial or full hydrogenation. Other atoms or molecules may be added as the group R instead of the hydrogen according to equation (2) to form other modified endohedral metallofullerenes. For example, atoms including, but not limited to chlorine, bromine, fluorine, iron, argon, and oxygen, as well as various combinations, compounds and molecules that contain these atoms may be added to the fullerene cage to form other modified endohedral metallofullerenes. Exemplary methods of making endohedral metallofullerenes is provided by Dorn et al., U.S. Pat. No. 6,303,760. Hydrogenation of endohedral metallofullerenes is described by Dorn et al., US Patent Application Publication No. 2007/0280873, for example. Processes of adding other R groups may include, but are not limited to, halogenation and arylation. In some embodiments, the endohedral metallofullerene, whether modified or un-modified, may be arranged in clusters or as polymers.

According to various embodiments of the present invention, the endohedral metallofullerene acting as a fullerene-based active material is coupled to an optical field of an optical waveguide. In particular, the endohedral metallofullerene may be located adjacent to an optical waveguide such that the endohedral metallofullerene is exposed to or intersects a portion of the optical field of optical waveguide. Such exposure is also referred to herein as ‘optical coupling’ between the optical field and the endohedral metallofullerene. In some embodiments, the location of the endohedral metallofullerene insures exposure or optical coupling to a relative high field region of the optical field within the optical waveguide. Notably, the use of endohedral metallofullerenes that incorporate rare earth ions according to various embodiments of the present invention facilitate considerably higher densities of the rare earth ions than can be achieved in other active materials that have been proposed for use in photonic devices. For example, when using endohedral metallofullerenes it may be possible to provide more erbium (Er) ions per unit volume than is practical with other means (e.g., by doping an oxide with Er).

In some embodiments, the optical waveguide comprises a low-index-core optical waveguide (e.g., a slot optical waveguide). In some of these embodiments, the endohedral metallofullerene is located in a low-index region or core of the low-index-core optical waveguide. Herein, a ‘low-index-core optical waveguide’ is defined as an optical waveguide having a core in which a refractive index is relatively lower than a refractive index of a surrounding region outside the core. The region with the relatively lower index of refraction is referred to as a ‘low index region’ or ‘low index core’. In such low-index-core optical waveguides, a majority of an optical field propagating therein is essentially confined to the low index core. That is, the optical field propagates along an axis located in the low index core of the low-index-core optical waveguide. In other words, the guiding structure of the low-index-core optical waveguide comprises the low index core.

The low-index-core optical waveguide, as defined herein, is distinguished from a conventional or high-index optical waveguide (e.g., a fiber optic waveguide) in that the high-index optical waveguide includes a guiding structure with a core that has a higher refractive index than the surrounding material. In some exemplary embodiments of the present invention, the low-index-core optical waveguide is a slot optical waveguide. In other exemplary embodiments, the low-index-core optical waveguide uses a photonic bandgap crystal adjacent to the low index region to confine the optical field propagating within the optical waveguide core. Other examples of low-index-core optical waveguides include, but are not limited to, a holey fiber and a Bragg fiber with a hollow core.

As defined herein, ‘slot optical waveguide’ refers to a low-index-core optical waveguide comprising a sub-micron, low refractive index slot bounded by a pair of walls having a relatively higher index of refraction. Specifically, the slot has a refractive index that is less than, and in some embodiments much less than, a refractive index of a material of the walls. For example, a refractive index of the slot may be about 1.0 (e.g., air) while the walls may have a refractive index of about 3.5 (e.g., silicon). As such, the slot may be referred to as a ‘low refractive index slot’ or ‘low-index’ slot while the walls are often referred to as ‘high refractive index walls’ or ‘high-index’ walls. The slot optical waveguide is also referred to as simply a ‘slot waveguide’ herein. Furthermore, the slot waveguide is a representative embodiment of a low-index-core optical waveguide. As such, the terms ‘slot waveguide’ and ‘low-index-core optical waveguide’ are generally used interchangeably herein unless a distinction is necessary for proper understanding.

Operation of the slot optical waveguide may be understood as a mode construction of two ‘high-index’ optical waveguide modes of an optical signal or optical power propagating in the high refractive index walls that bound the low refractive index slot. In particular, a high contrast discontinuity in an electric field of the optical signal is created at an interface between the low refractive index slot and the high refractive index walls. A quasi-transverse electric (TE) mode of the optical signal propagating through the slot optical waveguide structure experiences a discontinuity that is proportional to the square of the ratio of the high refractive index of the walls and the low refractive index of the slot. When a width of the slot is comparable to a decay length of the electric field, the high contrast discontinuity produces a relatively strong overlap of the two high-index waveguide modes within the slot. The strong overlap results in a power density of the field within the low refractive index slot that is relatively constant across the slot and may be higher than the field within the high refractive index walls. As such, a significant portion the optical signal is generally carried by or in the slot of the slot waveguide. Moreover, the optical field intensity of the optical signal within the slot represents a high intensity region relative to the optical field intensity in an area surrounding the slot.

In various embodiments, a particular width of the slot depends, in part, on a refractive index of a material of the walls and a refractive index of the slot region of the slot waveguide. For example, a slot waveguide having walls comprising silicon (Si) and having a slot that is essentially filled with air or another relatively low refractive index material such as, but not limited to, silicon dioxide (SiO₂), may have a slot width on the order of about 50 nanometers (nm) to about 100 nm. Generally, a slot width of less than about 200 nm may be employed for a wide variety of practical materials, including but not limited to various endohedral metallofullerenes. Additional details regarding slot optical waveguide design and operation are provided by Lipson et al., U.S. Patent Application Publication 2006/0228074 A1, and Barrios et al., U.S. Patent Application Publication 2007/0114628 A1, for example.

In addition to the slot waveguide described above, essentially any optical waveguide that confines the optical field of the optical waveguide to a vicinity of the endohedral metallofullerene-based active material may be employed without departing from the intended scope of the present invention. For example, a holey waveguide filled with the endohedral metallofullerene may be used. Similarly filled, photonic band gap and Bragg fibers also may be employed. In other embodiments, the endohedral metallofullerene is coupled to an evanescent field of the optical waveguide. Coupling to the evanescent field is instead of or in addition to intersecting or being collocated with the high field region along the axis of the optical waveguide.

In some embodiments that employ evanescent field coupling, the optical waveguide may comprise a ridge-loaded optical waveguide. As used herein, ‘ridge-loaded optical waveguide’ refers to an optical waveguide comprising a relatively thin slab layer comprising a slab or sheet of a first material (i.e., the ‘slab layer’) overlying a layer (i.e., a ‘support layer’) of a second material. The first material of the slab layer has a refractive index that is generally higher than a refractive index of the second material of the underlying support layer. Furthermore, the first material of the slab layer is generally transparent to the electromagnetic signal at optical wavelengths (i.e., an optical signal).

An optical signal propagating in the ridge-loaded optical waveguide is effectively confined to and preferentially propagates within the slab layer of the first material. In particular, the difference between the refractive index of the first material and the second material facilitates the confinement of the optical signal to the slab layer. As such, the ridge-loaded optical waveguide is a member of a class of optical waveguides known as ‘slab optical waveguides’. The ridge-loaded optical waveguide is also referred to as simply a ‘ridge waveguide,’ herein.

In some embodiments, a thickness of the slab layer of the ridge-loaded optical waveguide is selected to preferentially sustain a lower order propagating mode of the propagating optical signal. For example, the thickness may be less than a particular thickness such that only a first transverse electric mode (i.e., TE₁₀) can propagate. The particular thickness depends on a refractive index of a material of the slab layer as well as other specific physical characteristics thereof.

For example, the slab layer may comprise a semiconductor material that is compatible with the propagating optical signal such as, but not limited to, silicon (Si), gallium arsenide (GaAs), and lithium niobate (LiNbO₃). In some embodiments, the slab layer comprises the endohedral metallofullerene or a portion thereof. The second material layer may be an oxide-based insulator layer (e.g., silicon oxide when the slab layer is silicon), for example. In another example, the second material layer is an insulator layer of a semiconductor-on-insulator (SOI) substrate upon which the slab layer is deposited. Other materials that may be used for the slab layer and the second material layer may include, but are not limited to, glass (e.g., borosilicate glass) and various polymers (e.g., polycarbonate). Any of a single crystalline, polycrystalline or amorphous layer of a dielectric material or of a semiconductor material may be employed, according to various embodiments. A transparency of the slab layer material may affect an optical loss of the ridge-loaded optical waveguide. For example, the less transparent the material, the more loss is experienced by the optical signal.

The ridge-loaded optical waveguide further comprises a ridge extending from a surface of the slab layer on a side opposite the support layer. The ridge acts to further confine the propagating optical signal to a vicinity of the slab layer immediately below the ridge. As such, the propagating optical signal effectively follows or propagates along the ridge of the ridge-loaded optical waveguide. Information for determining the width and the height of the ridge as well as a thickness of the slab layer may be readily obtained from conventional design guidelines and using computer design models for ridge-loaded optical waveguides.

In yet other embodiments, the optical waveguide may comprise a strip optical waveguide. As defined herein, the strip optical waveguide, or simply ‘strip waveguide’, comprises a strip layer and a support layer. The strip optical waveguide further comprises a strip formed in or from the strip layer. In particular, the strip may be formed in the strip layer by etching parallel channels in the strip layer to define the strip. The channels optically isolate the strip from the strip layer to facilitate confinement of the optical signal to the strip. In other embodiments, the strip comprises the entire strip layer. For example, the strip layer may be essentially removed by etching to leave only the strip during fabrication. As such, channels are not explicitly present after fabrication or alternatively may be considered as having ‘infinite’ width.

The optical energy within the strip waveguide is essentially confined to the strip by the presence of sidewalls of the strip. A material boundary exists at the sidewalls between a material of the strip layer and air or another dielectric material within the channels. The boundary represents a change in a refractive index across the boundary. The refractive index change causes an optical signal to be tightly bound to the strip due to total internal reflection therewithin. Again, as with the ridge-loaded optical waveguide, the endohedral metallofullerene is generally coupled to an evanescent field when a strip optical waveguide is employed, according to embodiments of the present invention.

According to some embodiments of the present invention, the endohedral metallofullerenes may be coupled to the propagating optical signal in either the ridge-loaded optical waveguide or the strip optical waveguide. In particular, the endohedral metallofullerenes may be formed as a layer adjacent to the ridge of the ridge-loaded optical waveguide. Similarly, the endohedral metallofullerenes may be formed as a layer adjacent to the strip (e.g., in the channels and on a top of the strip) of the strip optical waveguide.

According to various embodiments herein, the optical apparatus may be realized in a relatively compact and space-efficient form factor. Moreover, the optical apparatus may be readily fabricated in an integrated form as part of a larger circuit or photonic system. In particular, according to various embodiments of the present invention, the optical apparatus is well-suited to fabrication on or in a substrate such as, but not limited to, a multilayer semiconductor or insulator substrate. Fabrication on or in the substrate facilitates integrating the optical apparatus with other photonic and non-photonic components including, but not limited to, one or more of passive photonic components, active photonic components, passive electronic components and active electronic components.

For example, the optical apparatus may be fabricated directly in a surface layer (e.g., a thin film semiconductor layer) of a semiconductor-on-insulator (SOI) substrate. The surface layer may be a single-crystal silicon, an amorphous silicon, or a polysilicon thin film layer of a silicon-on-insulator substrate, for example. Other photonic components similarly may be fabricated on or in the same semiconductor substrate and integrated with the optical apparatus, according to some embodiments of the present invention. Such photonic components that may be integrated with the optical apparatus include, but are not limited to, optical signal transmission structures (e.g., other optical waveguides), optical amplifiers, optical switches and optical modulators.

In some embodiments, the optical waveguide and the endohedral metallofullerene-based active material are arranged as an optical resonator. For example, a segment of the low-index-core optical waveguide (e.g., slot waveguide) containing the endohedral metallofullerenes in the low-index region (e.g., the slot) may be located between a pair of mirrors to produce a Fabry-Perot (i.e., standing-wave) resonator. In another example, the optical resonator may be realized as a ring resonator in which one or more segments of the endohedral metallofullerene-containing low-index-core optical waveguide are arranged in closed loop. In some of these embodiments, the optical resonator may be referred to as a ‘folded cavity’ resonator because mirrors are employed along (as opposed to at the ends of) an optical path within the optical resonator. In particular, mirrors may be employed to introduce an abrupt change in a direction of the propagating signal within the optical resonator. In other words, an optical path within the resonator is effectively ‘folded’ by a presence of the mirror. In some embodiments, the mirrors allow the optical resonator to be realized in a more compact and space-efficient shape than would be possible otherwise. Total internal reflection mirrors may be employed to realize the folded cavity of the optical resonator, according to some embodiments.

A total internal reflection mirror (TIR mirror) is defined as a mirror that reflects or changes a direction of an optical signal using total internal reflection. Total internal reflection is a well-known optical phenomenon. Total internal reflection of an optical signal traveling in a material occurs when the optical signal encounters a material boundary at an angle greater than a critical angle relative to a normal of the boundary. In particular, when the material boundary represents a change in refractive index from a higher refractive index to a lower refractive index, the optical signal beyond the critical angle will be essentially unable to penetrate the boundary and will be reflected away from the boundary. The reflection obeys the law of reflection in that a reflection angle equals an angle of incidence on the boundary. An example of a boundary that may provide total internal reflection and thus, be employed as a TIR mirror, is a boundary between a high index material and a low index material (e.g., glass or silicon and air).

The terms ‘semiconductor’ and ‘semiconductor materials’ as used herein independently include, but are not limited to, semiconductor elements and compounds from group IV, compound semiconductors from groups III and V, and compound semiconductors from groups II and VI of the Periodic Table of the Elements, or another semiconductor material that forms any crystal orientation. For example, and not by way of limitation, a semiconductor substrate may be a silicon-on-insulator wafer with a (111)-oriented silicon layer (i.e., top layer), or a single, free-standing wafer of (111) silicon, depending on the embodiment. The semiconductor materials that are rendered electrically conductive, according to some embodiments herein, are doped with a dopant material to impart a targeted amount of electrical conductivity (and possibly other characteristics) depending on the application.

An insulator or an insulator material useful for the various embodiments of the invention is any material that is capable of being made insulating including, but not limited to, a semiconductor material from the groups listed above, another semiconductor material, and an inherently insulating material. Moreover, the insulator material may be an oxide, a carbide, a nitride or an oxynitride of any of those semiconductor materials such that insulating properties of the material are facilitated. Alternatively, the insulator may comprise an oxide, a carbide, a nitride or an oxynitride of a metal (e.g., aluminum oxide) or even a combination of multiple, different insulating materials.

Herein, an ‘optical pump’ is defined as an electromagnetic wave or signal (e.g., light) that raises or ‘pumps’ electrons in an active laser medium or material (i.e., an active material) from a lower energy level to a higher energy level. Effectively, the pumped electrons store in the active material energy that is provided or furnished by the optical pump. Decay of the pumped electrons back to a lower energy level may release photons resulting in one or both of spontaneous emission and stimulated emission. In particular, when considering an optical amplifier, an input signal coupled to the active material may stimulate the decay and give rise to stimulated emission which effectively amplifies (i.e., adds power to) the input signal resulting in an amplified output signal. In the case of a laser (i.e., laser oscillator or laser source), decay of the pumped electrons initially produces spontaneous emission. The spontaneous emission in conjunction with a resonant cavity or resonator, in turn, may produce stimulated emission from the active material that provides an output of the laser. The optical pump may be provided by an optical source such as, but not limited to, a light emitting diode (LED) or a laser, for example. The optical source may be referred to as an ‘optical pump source’. The optical pump source is generally separate from a source that provides the input signal for the optical amplifier.

For simplicity herein, no distinction is made between a substrate and any layer or structure on the substrate unless such a distinction is necessary for proper understanding. Additionally, all waveguides described herein are optical waveguides so that omission of the term ‘optical’ when referring to a ‘waveguide’ does not change the intended meaning of that being described. Further, as used herein, the article ‘a’ is intended to have its ordinary meaning in the patent arts, namely ‘one or more’. For example, ‘a segment’ means one or more segments and as such, ‘the segment’ means ‘the segment(s)’ herein. Also, any reference herein to ‘top’, ‘bottom’, ‘upper’, ‘lower’, ‘up’, ‘down’, ‘front’, back', ‘left’ or ‘right’ is not intended to be a limitation herein. Moreover, examples herein are intended to be illustrative only and are presented for discussion purposes and not by way of limitation.

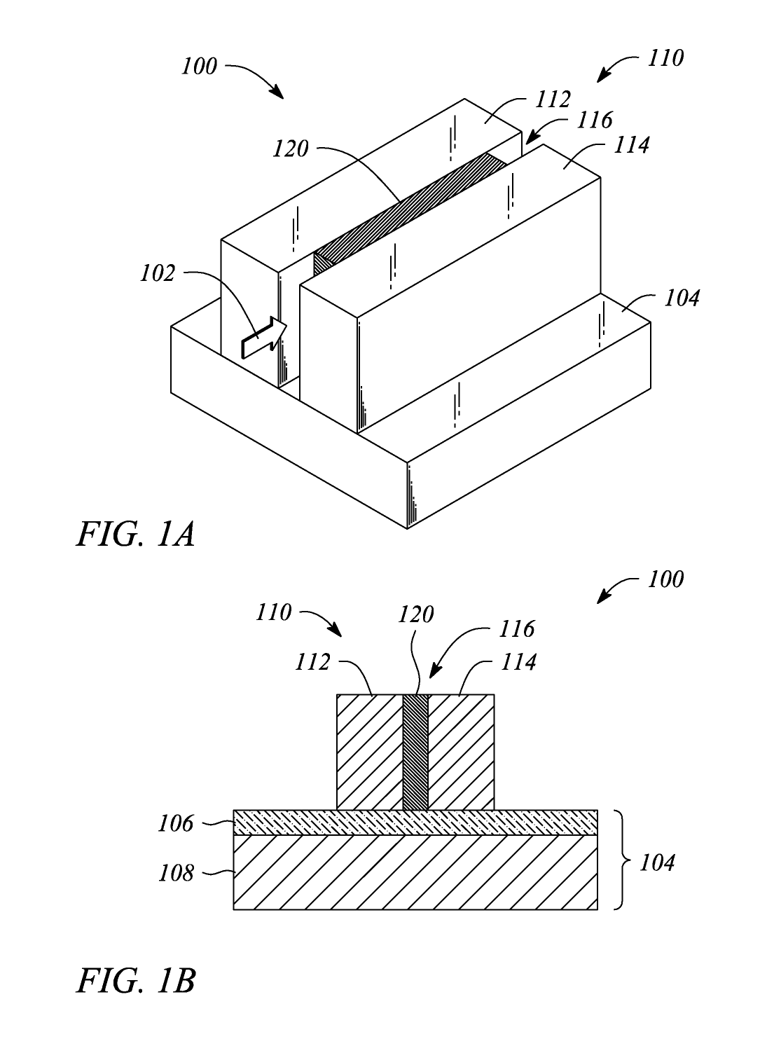

FIG. 1A illustrates a perspective view of an optical apparatus 100, according to an embodiment of the present invention. FIG. 1B illustrates a cross sectional view of the optical apparatus 100, illustrated in FIG. 1A. When exposed to an optical pump 102, the optical apparatus 100 produces an optical output or provides light amplification by stimulated emission. In some embodiments, the stimulated emission produced by exposure of the optical apparatus 100 to the optical pump 102 may comprise a wavelength that differs from a wavelength of the optical pump 102. In some embodiments, the optical apparatus is supported by a substrate 104. In some embodiments, the substrate 104 may comprise an insulating layer 106 over another layer 108, for example.

The optical apparatus 100 comprises an optical waveguide 110. In particular, as illustrated in FIGS. 1A and 1B, the optical waveguide 110 comprises a slot optical waveguide 110. The slot optical waveguide 110 comprises a first high index wall 112 and a second high index wall 114. The first and second high index walls 112, 114 are spaced apart from one another to form a low index slot 116 between the high index walls 112, 114, respectively. As illustrated in FIGS. 1A and 1B, the slot 116 is vertically oriented (i.e., a vertical slot 116). In other embodiments (not illustrated), the slot may be horizontally oriented and the two high-index region are above and below the slot respectively (i.e., a horizontal slot).

The optical apparatus 100 further comprises an endohedral metallofullerene 120. In practice, the endohedral metallofullerene 120 comprises a layer, a film, a coating or a deposit having a plurality of fullerene cages. In some embodiments, the layer, the film, the coating or the deposit comprises a large plurality (e.g., millions, billions, or trillions) of fullerene cages. The fullerene cages of the plurality may be packed relatively closely together within the layer, the film, the coating or the deposit, according to some embodiments. For example, the fullerene cages may be effectively touching one another within the layer, the film, the coating or the deposit.

In some embodiments, a metal contained by a fullerene cage of the endohedral metallofullerene 120 be a single type of metal. For example, the endohedral metallofullerene may comprise erbium (Er) in the fullerene cages (i.e., an erbium-doped endohedral metallofullerene). In other embodiments, the metal within the fullerene cages of the endohedral metallofullerene may be a plurality of different metals. In some embodiments, with a plurality of different metals, the different metals may be in different fullerene cages. For example, some fullerene cages of the endohedral metallofullerene may contain Er ions while other fullerene cages may contain scandium (Sc) or yttrium (Y). In other embodiments that include a plurality of different metals, the different metals may be in the same fullerene cages. For example, a given fullerene cage may have an atom of Er and an atom of neodymium (Nd). In some embodiments, in addition to the fullerene cages containing metal ions, some of the fullerene cages may be effectively empty or at least contain no metal ions.

The endohedral metallofullerene 120 of the optical apparatus 100 is optically coupled to an optical field of the optical waveguide 110. In some embodiments, the endohedral metallofullerene 120 is optically coupled by being within a region of high optical field of the optical waveguide 110. For example, the endohedral metallofullerene 120 may effectively intersect an optical axis of the optical waveguide 110. In other embodiments, the endohedral metallofullerene 120 may be optically coupled by being adjacent to but not collocated with a region of high optical field of the optical waveguide 110. For example, the endohedral metallofullerene 120 may be located in an evanescent field of the optical field of the optical waveguide 110.

Referring again to FIGS. 1A and 1B, the endohedral metallofullerene 120 is illustrated within the slot 116 of the slot optical waveguide 110. The optical axis of the slot optical waveguide 110 is located in the slot 116. Locating the endohedral metallofullerene 120 in the slot 116 places the endohedral metallofullerene 120 in the high optical field of the slot optical waveguide 110. Any of a variety of means may be employed to locate the endohedral metallofullerene 120 in the slot 116.

For example, the endohedral metallofullerene 120 may be formed as powder and deposited (e.g., dusted or packed) into the slot 116. In another example, the endohedral metallofullerene 120 may be dissolved and/or otherwise suspended in a solution. The solution may then be used as a vehicle for depositing the endohedral metallofullerene 120 into the slot 116. For example, the slot optical waveguide 110 may be immersed in and then removed from the solution. After drying, a film containing the endohedral metallofullerene 120 will remain on a surface and in the slot 116 of the slot optical waveguide 110. In another example, the solution may be deposited onto slot optical waveguide in droplet form (e.g., using an inkjet printer) and subsequently allowed to dry. In yet another example, the endohedral metallofullerene 120 may be deposited by spin coating the solution on the slot optical waveguide 110.

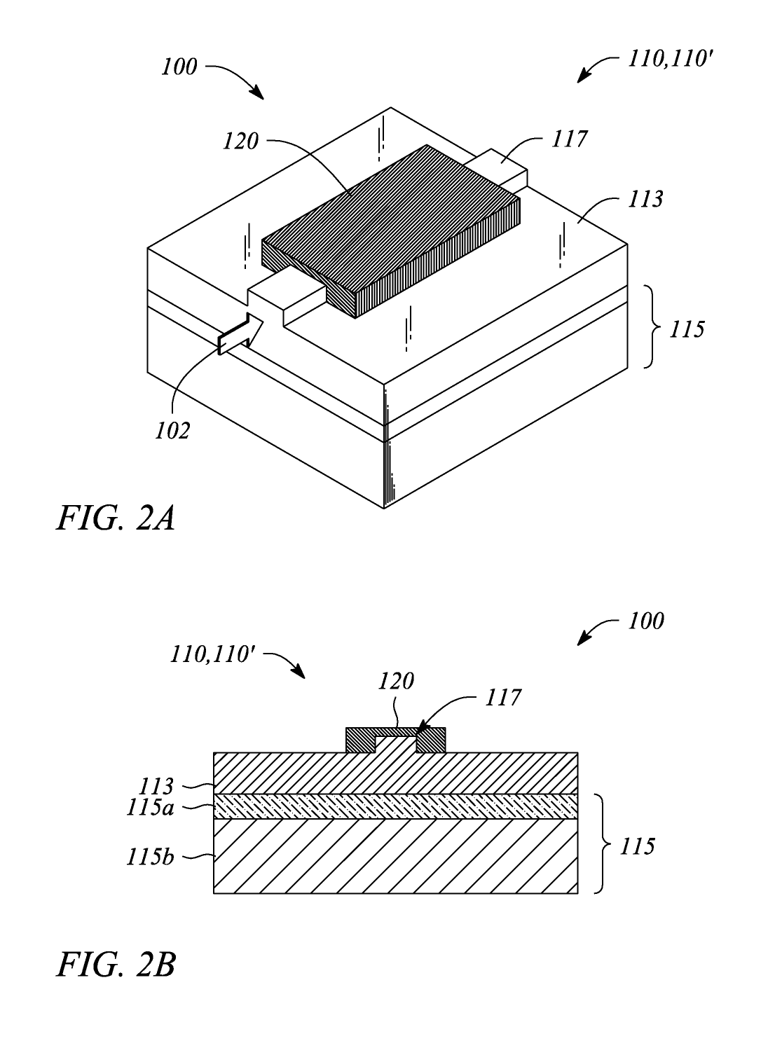

FIG. 2A illustrates a perspective view of an optical apparatus 100, according to another embodiment of the present invention. FIG. 2B illustrates a cross sectional view of the optical apparatus 100, illustrated in FIG. 2A. As provided above for FIGS. 1A and 1B, the optical apparatus 100 embodiment of FIGS. 2A and 2B comprises an optical waveguide 110. As illustrated in FIGS. 2A and 2B, the optical waveguide 110 comprises a ridge-loaded optical waveguide 110′ instead of a slot waveguide. The ridge-loaded optical waveguide 110′ comprises a slab layer 113 overlying a support layer 115. The ridge-loaded optical waveguide 110′ further comprises a ridge 117 extending from a top surface (as illustrated) of the slab layer 113. As illustrated in FIGS. 2A and 2B, the top surface of the slab layer 113 is on a side of the slab layer 113 that is opposite a side of the slab layer 113 adjacent to the support layer 115. In some embodiments, the support layer 115 may comprise an insulator layer 115a on top of another layer 115b (e.g., a substrate). The combination of the slab layer 113 and the support layer 115 comprising the insulator layer 115a may be realized as a semiconductor on insulator (SOI) substrate, for example.

The optical apparatus 100 embodiment in FIGS. 2A and 2B also further comprises an endohedral metallofullerene 120. In FIGS. 2A and 2B, the endohedral metallofullerene 120 is illustrated as coating or film on the ridge 117 of the ridge-loaded optical waveguide 110′ and on the top surface of the slab layer 113 adjacent to the ridge 117. The coating or film may be held in place by a passivation layer (not illustrated), deposited on or over the coating or film, for example. As illustrated, the endohedral metallofullerene 120 is exposed to an evanescent field(s) of the optical field propagating within the ridge-loaded optical waveguide 110′. The evanescent field effectively provide optical coupling between the endohedral metallofullerene 120 and the optical field to the ridge-loaded optical waveguide 110′. In general, an index of refraction of the endohedral metallofullerene 120 is higher than that of a vacuum or of air that would be above the ridge-loaded optical waveguide 110′ in the absence of the endohedral metallofullerene 120. As such, the evanescent field may extend further above the ridge-loaded optical waveguide 110′ and thus further into the endohedral metallofullerene 120 than would otherwise be the case.

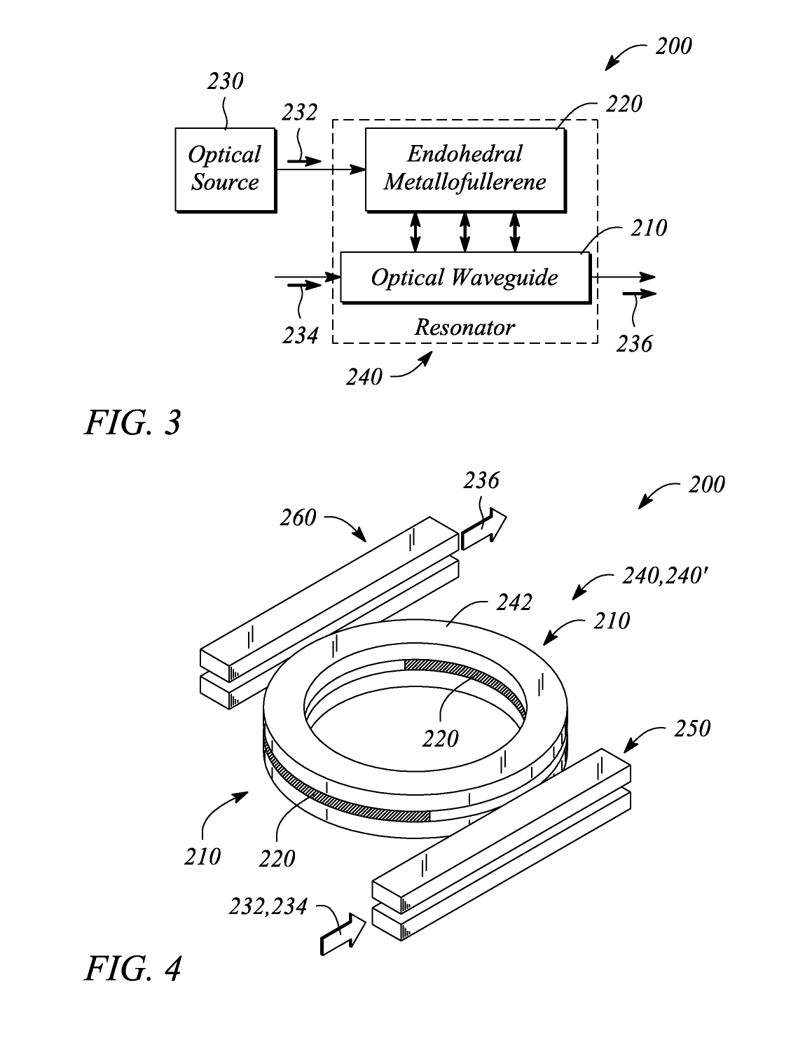

FIG. 3 illustrates a block diagram of an optical system 200, according to an embodiment of the present invention. The optical system 200 may be an optical or laser amplifier, for example. The optical system 200 comprises an optical waveguide 210 and an endohedral metallofullerene 220. The endohedral metallofullerene 220 is optically coupled to an optical field of the optical waveguide 210. Optical coupling is illustrated as heavy, doubled-headed arrows in FIG. 3.

In some embodiments, the endohedral metallofullerene 220 is optically coupled to a high field region of the optical waveguide 210. For example, the endohedral metallofullerene 220 may be located in a core or on an optical axis of the optical waveguide 210. Such an optical axis may comprise a slot of a slot optical waveguide, for example. In another example, the endohedral metallofullerene 220 may be located in a hollow core or similar hollow region of either a photonic bandgap waveguide or a photonic crystal or holey optical fiber.

In other embodiments, the endohedral metallofullerene 220 may be optically coupled to an evanescent field of the optical waveguide 210. For example, the endohedral metallofullerene 220 may be located in a vicinity of an evanescent field at or just above a surface of a ridge-loaded optical wave guide. In another example, the endohedral metallofullerene 220 is coupled to an optical field in a vicinity of a strip optical waveguide by locating the endohedral metallofullerene 220 next to or on top of the strip (e.g., in the channels along the sides for the strip optical waveguide).

The optical system 200 further comprises an optical source 230. The optical source 230 generates optical power 232 (e.g., light) that pumps and stores energy in the endohedral metallofullerene 220. Since the optical power 232 generated by the optical source 230 pumps the endohedral metallofullerene 220, the optical power 232 is also referred to as an ‘optical pump’ 232.

As illustrated in FIG. 3, the optical pump 232 is depicted as being applied to the endohedral metallofullerene 220 to emphasize that the optical power 232 pumps the endohedral metallofullerene 220. In some embodiments, the optical pump 232 may be applied directly to the endohedral metallofullerene 220 (e.g., by direct illumination). In other embodiments, the optical pump 232 is coupled into the endohedral metallofullerene 220 from the optical waveguide 210.

The energy stored in the endohedral metallofullerene 220 is released as an emission by decay of pumped electrons. In particular, when the optical system 200 implements an optical amplifier, the stored energy may be released as a stimulated emission. For example, the stimulated emission may be stimulated by the introduction of an input signal 234 into the optical system 200. The input signal 234 may be introduced through the optical waveguide 210, for example. In some embodiments, the stimulated emission adds to the input signal 234 to produce an optical output 236. Alternatively, when the optical system 200 implements a laser, the energy stored in the pumped endohedral metallofullerene 220 produces a spontaneous emission. The spontaneous emission may, in turn, produce further stimulated emission from the pumped endohedral metallofullerene 220. The optical output 236 of the laser comprises one or both of the stimulated emission and the spontaneous emission.

In some embodiments, the optical pump 232 has a wavelength that differs from and is generally shorter than a wavelength of the emission from the endohedral metallofullerene 220. For example, the optical pump 232 may have a wavelength of about 980 nanometers (nm) while the emission (e.g., stimulated emission and/or spontaneous emission) of an exemplary erbium-doped endohedral metallofullerene 220 may have a wavelength of about 1520 nm.

In some embodiments, the optical system 200 further comprises an optical resonator 240 that comprises the optical waveguide 210. In particular, the optical waveguide 210 may be a portion of an optical waveguide within the optical resonator 240. In such embodiments, the optical amplifier provided by the optical system 200 may implement a laser. For example, the optical resonator 240 may be employed to feed back a portion of one or both of the spontaneous emission and the stimulated emission from the pumped endohedral metallofullerene 220 to produce further stimulated emission and effect laser oscillation (e.g., ‘lasing’) by the laser.

FIG. 4 illustrates a perspective view of an optical system 200 that comprises a resonator 240, according to an embodiment of the present invention. In particular, FIG. 4 illustrates the resonator 240 implemented as a ring resonator 240′. As illustrated, the optical waveguide 210 and coupled endohedral metallofullerene 220 comprise a portion or portions of a ring-shaped optical waveguide 242 of the ring resonator 240′. For example, the optical waveguide 210 and coupled endohedral metallofullerene 220 may comprise segments of the ring-shaped optical waveguide 242 located within two quadrants on opposite sides of the ring resonator 240′, as illustrated in FIG. 4. In another example (not illustrated), the optical waveguide 210 and the coupled endohedral metallofullerene 220 may comprise effectively the entire ring-shaped optical waveguide 242.

The optical waveguide 210 is illustrated in FIG. 4 as a slot optical waveguide with the endohedral metallofullerene 220 located in a slot of the slot optical waveguide by way of example. The slot optical waveguide is oriented horizontally relative to the slot optical waveguide illustrated in FIGS. 1A and 1B, for example. Alternatively, the optical waveguide 210 may be implemented as another type of optical waveguide including but not limited to a ridge-loaded optical waveguide (not illustrated).

The ring resonator 240′ illustrated in FIG. 4 further comprises an input optical waveguide 250. The input optical waveguide 250 is coupled to the ring-shaped optical waveguide 242. In some embodiments, the input optical waveguide 250 may receive the optical pump 232 from the optical source (not illustrated in FIG. 4) and couple the received optical pump 232 to the ring-shaped optical waveguide 242. In some embodiments, a coupling between the input optical waveguide 250 and the ring-shaped optical waveguide 242 is a critical coupling. A critical coupling optimizes an amount of optical power that is coupled from the input optical waveguide 250 to the ring-shaped optical waveguide 242. In some embodiments, the input optical waveguide 250 may further receive and communicate to the ring-shaped optical waveguide 242 the input signal 234. In such embodiments, the optical pump 232 may or may not be introduced by way of the input optical waveguide 242. For example, the optical pump 232 may illuminate the endohedral metallofullerene 220 from above the ring-shaped optical waveguide 242 instead of or in addition to being coupled in from the input optical waveguide 250.

The ring resonator 240′ illustrated in FIG. 4 further comprises an output optical waveguide 260 coupled to the ring-shaped optical waveguide 242. The output optical waveguide 260 receives the optical output 236 produced by the emission of the endohedral metallofullerene 220 in the ring-shaped optical waveguide 242. In some embodiments, a coupling of the optical waveguide 260 to the ring-shaped optical waveguide is optimized to facilitate stimulated emission by the endohedral metallofullerene 220 and further to provide efficient power transfer out of the ring oscillator 240′. For example, when the optical system 200 implements a laser, the coupling may be optimized to facilitate power transfer while insuring that stimulated emission occurs (e.g., that a proper condition for population inversion within the endohedral metallofullerene 220 is maintained).

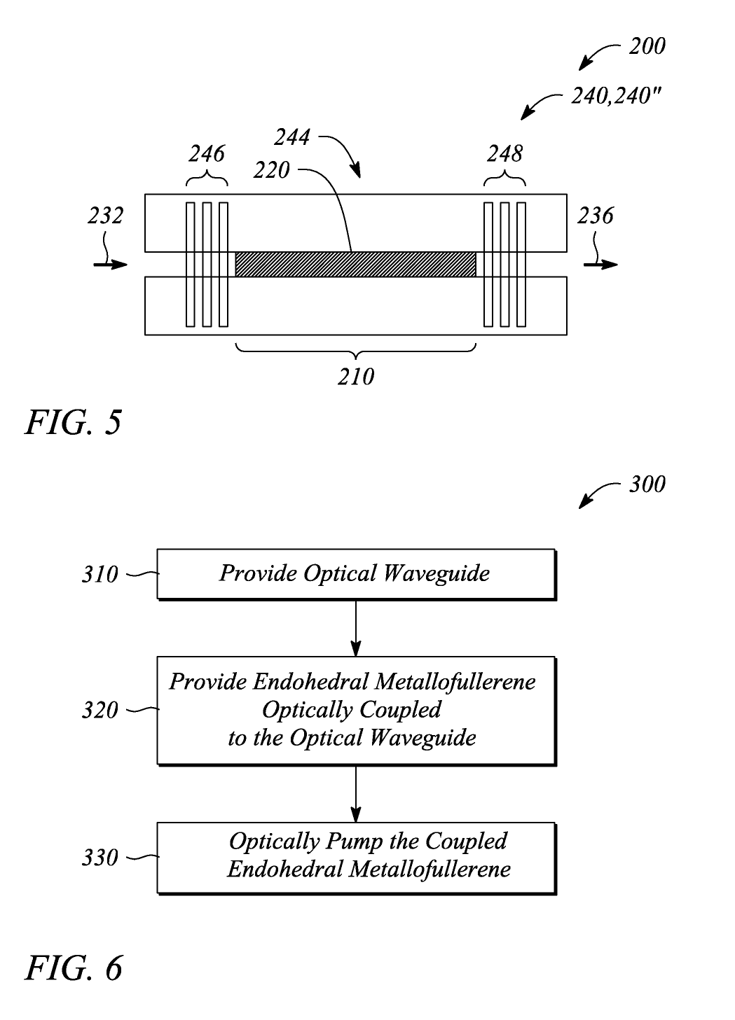

FIG. 5 illustrates a top view of an optical system 200 that comprises a resonator 240, according to another embodiment of the present invention. In particular, the resonator 240 illustrated in FIG. 5 is implemented as a linear resonator 240″. The linear resonator 240″ may be a Fabry-Perot resonator, for example. As illustrated, the linear resonator 240″ comprises an optical waveguide segment 244 disposed between a first mirror 246 and a second mirror 248. In some embodiments, the optical waveguide segment 244 is effectively a straight segment of optical waveguide 210. The first and second mirrors 246, 248 may be implemented as distributed feedback Bragg (DFB) reflectors, for example.

The optical waveguide segment 244 comprises the optical waveguide 210 and the coupled endohedral metallofullerene 220. For example, the optical waveguide segment 244 may be the optical waveguide 210, as illustrated in FIG. 5. In another example (not illustrated), the optical waveguide 210 and the coupled endohedral metallofullerene 220 make up a portion of the optical waveguide segment 244 instead of the whole segment 244 between the first and second mirrors 246, 248.

Optical power 232 from the optical source (not illustrated in FIG. 5) is coupled into the linear resonator 240″ through the first mirror 246, for example. The optical power 232 that is coupled into the linear resonator 240″ pumps the endohedral metallofullerene 220 to produce stimulated emission 234. The stimulated emission 234 is coupled out of the linear resonator 240″ as the optical output 236 through the second mirror 248, for example.

FIG. 6 illustrates a flow chart of a method 300 of light amplification by stimulated emission, according to an embodiment of the present invention. The method 300 of light amplification by stimulated emission comprises providing 310 an optical waveguide. For example, the provided 310 optical waveguide may comprise one or more of a slot optical waveguide, a ridge-loaded optical waveguide and a strip optical waveguide. The optical waveguide may be provided 310 as an integrated structure on a substrate, for example. Conventional semiconductor fabrication (e.g., etching) may be used to provide 310 the optical waveguide, according to some embodiments.

The method 300 of light amplification by stimulated emission further comprises providing 320 an endohedral metallofullerene. The provided 320 endohedral metallofullerene is optically coupled to an optical mode of the optical waveguide. According to some embodiments, coupling is accomplished by effectively co-locating the endohedral metallofullerene and the optical mode or a portion thereof. For example, the provided 320 endohedral metallofullerene may be optically coupled to either a region of high field intensity (e.g., optical axis) of the optical waveguide or to an evanescent field of the optical mode of the optical waveguide.

The method 300 of light amplification by stimulated emission further comprises optically pumping 330 the coupled endohedral metallofullerene. Optically pumping 330 is accomplished by introducing an optical pump (i.e., optical power from an optical source) into the optical waveguide, according to some embodiments. In some embodiments, the optical pump may be provided by a laser, light from which optically pumps 330 the endohedral metallofullerene.

In some embodiments, the optical waveguide is an optical waveguide of a resonant cavity of an optical resonator. In some embodiments, the optical waveguide comprises a slot optical waveguide with the endohedral metallofullerene being provided 320 in a slot of the slot optical waveguide. In other embodiments, the optical waveguide is one of a ridge-loaded optical waveguide and a strip optical waveguide. In these embodiments, the endohedral metallofullerene may be provided 320 as a coating or film on top of or surrounding the optical waveguide.

Thus, there have been described embodiments of an optical apparatus, an optical system and a method of light amplification by stimulated emission that employ an endohedral metallofullerene as an active material coupled to an optical waveguide. It should be understood that the above-described embodiments are merely illustrative of some of the many specific embodiments that represent the principles of the present invention. Clearly, those skilled in the art can readily devise numerous other arrangements without departing from the scope of the present invention as defined by the following claims.

What is claimed is:

1. An optical apparatus (100) comprising:
an optical waveguide (110); and
an endohedral metallofullerene (120) that is optically coupled to an optical field of the optical waveguide (110).

2. The optical apparatus (100) of claim 1, wherein the endohedral metallofullerene (120) comprises an erbium-doped endohedral metallofullerene (120), wherein the coupled optical field facilitates an emission in the endohedral metallofullerene (120).

3. The optical apparatus (100) of claim 1, wherein the optical waveguide (110) comprises a slot waveguide, the endohedral metallofullerene (120) being located within a slot of the slot optical waveguide.

4. The optical apparatus (100) of claim 1, further comprising an optical resonator, where the optical waveguide (110) is within and comprises a portion of a resonant cavity of the optical resonator.

5. The optical apparatus (100) of claim 4, wherein the optical resonator is a ring resonator.

6. The optical apparatus (100) of claim 4, wherein the optical resonator comprises the optical waveguide (110) disposed between two mirrors as a Fabry-Perot resonator.

7. The optical apparatus (100) of claim 6, wherein the optical waveguide (110) comprises a slot optical waveguide and the mirrors comprise distributed feedback Bragg reflectors.

8. The optical apparatus (100) of claim 1, further comprising an optical source, the optical source providing optical power that optically pumps and stores energy in the endohedral metallofullerene (120).

9. An optical system (200) comprising:
an endohedral metallofullerene (220) that is optically coupled to an optical field of an optical waveguide (210); and
an optical source (230) that generates optical power (232) that pumps and stores energy in the endohedral metallofullerene (210).

10. The optical system (200) of claim 9, further comprising an optical resonator (240) comprising the optical waveguide (210), wherein the optical system implements a laser.

11. The optical system (200) of claim 10, wherein the optical resonator (240) is a ring resonator (240′) and the optical waveguide (210) is a portion of a ring-shaped optical waveguide (242), the ring resonator (240′) further comprising:
an output optical waveguide (260) coupled to the ring-shaped optical waveguide (242), the output optical waveguide (260) receiving an optical output (236) produced by an emission of the pumped endohedral metallofullerene (220).

12. The optical system of claim 9, wherein the optical resonator (240) is a ring resonator (240′) and the optical waveguide (210) is a portion of a ring-shaped optical waveguide (242), the ring resonator (240′) further comprising:
an input optical waveguide (250) coupled to the ring-shaped optical waveguide (242) that one or both of receives the optical power (232), the received optical power (232) being stored as energy in the endohedral metallofullerene (220) and receives an input signal (234), the input signal (234) being coupled to the ring-shaped optical waveguide (242).

13. The optical system of claim 9, wherein the optical waveguide (210) comprises a slot optical waveguide, the endohedral metallofullerene (220) being located in a slot of the slot optical waveguide.

14. A method (300) of light amplification by stimulated emission comprising:
providing (310) an optical waveguide;
providing (320) an endohedral metallofullerene, the endohedral metallofullerene being optically coupled to an optical mode of the optical waveguide; and
optically pumping (330) the coupled endohedral metallofullerene by introducing an optical pump into the optical waveguide.

15. The method of light amplification by stimulated emission of claim 14, wherein the optical waveguide is an optical waveguide of a resonant cavity of an optical resonator, the optical waveguide comprising a slot optical waveguide with the endohedral metallofullerene being provided in a slot of the slot optical waveguide.
